(19) United States
(12) Patent Application Publication
(10) Pub. No.: US 2018/0005039 A1
(43) Pub. Date: Jan. 4, 2018

(54) METHOD AND APPARATUS FOR GENERATING AN INITIAL SUPERPIXEL LABEL MAP FOR AN IMAGE

(71) Applicant: THOMSON Licensing, Issy-les-Moulineaux (FR)

(72) Inventors: Joern JACHALSKY, WENNIGSEN (DE); Bodo ROSENHAHN, Ronnenberg (DE); Matthlas RESO, Coppenbruegge (DE)

(21) Appl. No.: 15/547,514

(22) PCT Filed: Jan. 20, 2016
(86) PCT No.: PCT/EP2016/051095

§ 371 Date: Jul. 30, 2017

(30) Foreign Application Priority Data
Jan. 30, 2015 (EP) 15305141.2

(51) Int. Cl. G06K 9/00; G06K 9/46; G06K 9/50

(52) U.S. Cl. CPC G06K 9/00744; G06K 9/4604; G06K 9/50

(57) ABSTRACT

A method and an apparatus for generating an initial superpixel label map for a current image from an image sequence are described. The apparatus includes a feature detector that determines features in the current image. A feature tracker then tracks the determined features back into a previous image. Based on the tracked features a transformer transforms a superpixel label map associated to the previous image into an initial superpixel label map for the current image.

### FIELD

The present principles relate to a method and an apparatus for generating an initial superpixel label map for a current image from an image sequence. In particular, the present principles relate to a method and an apparatus for generating an initial superpixel label map for a current image from an image sequence using a fast label propagation scheme.

### BACKGROUND

Superpixel algorithms represent a very useful and increasingly popular preprocessing step for a wide range of computer vision applications (segmentation, image parsing, classification etc.). Grouping similar pixels into so called superpixels leads to a major reduction of the image primitives, i.e. of the features that allow a complete description of an image, which results in an increased computational efficiency for subsequent processing steps or allows for more complex algorithms, which would be computationally infeasible on pixel level, and creates a spatial support for region-based features.

Superpixel algorithms group pixels into superpixels, “which are local, coherent, and preserve most of the structure necessary for segmentation at scale of interest” [1]. Superpixels should be “roughly homogeneous in size and shape” [1].

Many recent superpixel algorithms for video content rely on dense optical flow vectors to propagate segmentation results from one frame to the next. An assessment of the impact of the optical flow quality on the over-segmentation quality shows that it is indispensable for videos with large object displacement and camera motion. However, due to the high computational costs the calculation of a high quality, dense optical flow is not suitable for real-time applications.

### SUMMARY

It is an object to propose an improved solution for generating an initial superpixel label map for a current image from an image sequence.

According to one aspect of the present principles, a method for generating an initial superpixel label map for a current image from an image sequence comprises:
determining features in the current image;
tracking the determined features back into a previous image; and
transforming a superpixel label map associated to the previous image into an initial superpixel label map for the current image based on the tracked features.

Accordingly, a computer readable storage medium has stored therein instructions for generating an initial superpixel label map for a current image from an image sequence, which, when executed by a computer, cause the computer to:
determine features in the current image;
track the determined features back into a previous image; and
transform a superpixel label map associated to the previous image into an initial superpixel label map for the current image based on the tracked features.

The computer readable storage medium is a non-transitory volatile or non-volatile storage medium, such as, for example, a hard disk, an optical or magnetic disk or tape, a solid state memory device, etc. The storage medium thus tangibly embodies a program of instructions executable by a computer or a processing device to perform program steps as described herein.

Also, in one embodiment an apparatus for generating an initial superpixel label map for a current image from an image sequence comprises:
a feature detector configured to determine features in the current image;
a feature tracker configured to track the determined features back into a previous image; and
a transformer configured to transform a superpixel label map associated to the previous image into an initial superpixel label map for the current image based on the tracked features.

In another embodiment, an apparatus for generating an initial superpixel label map for a current image from an image sequence comprises a processing device and a memory device having stored therein instructions, which, when executed by the processing device, cause the apparatus to:
determine features in the current image;
track the determined features back into a previous image; and
transform a superpixel label map associated to the previous image into an initial superpixel label map for the current image based on the tracked features.

In order to transform the superpixel label map meshes consisting of triangles are generated for the current image and the previous image from the determined features. The mesh of the current image is then warped backward onto the mesh of the previous image. To this end for each triangle in the current image a transformation matrix of an affine transformation for transforming the triangle into a corresponding triangle in the previous image is determined. Using the determined transformation matrices the coordinates of each pixel in the current image are transformed into transformed coordinates in the previous image. The superpixel label map for the current image is then initialized at each pixel position with a label of the label map associated to the previous image at the corresponding transformed pixel position.

The proposed solution makes use of a fast label propagation scheme that is based on sparse feature tracking and mesh-based image warping. This approach significantly speeds up the propagation process due to a large reduction of the processing costs. At the same time the final superpixel segmentation quality is comparable to approaches using a high quality, dense optical flow.

In one embodiment the transformed coordinates are clipped to a nearest valid pixel position. In this way it is ensured that for each pixel position in the superpixel label map for the current image the label to be assigned from the label map associated to the previous image is unambiguous.

In one embodiment features are added at each corner and at the center of each border of the current image and the previous image. This ensures that that each pixel is covered by a triangle.

In one embodiment a pixel split-off from a main mass of a superpixel in the initial superpixel label map is assigned to a neighboring superpixel. This guarantees the spatial coherency of the superpixels.

The described approach is not only applicable to temporal image sequences. It can likewise be for the individual images of a multiview image and even for sequences of multiview images.

### BRIEF DESCRIPTION OF THE DRAWINGS

FIGS. 1a)-b) show two original cropped frames k and k+1;

FIGS. 2 a)-b) show sparse features found in frame k+1 and tracked back into frame k;

FIGS. 3a)-b) depicts a mesh obtained from triangulation of the feature points and deformed by the movement of the tracked features;

FIGS. 4a)-b) illustrates warping of a superpixel label map of frame k by an affinity transformation according to the deformation of the mesh for an initialization for frame k+1;

FIG. 5 illustrates warping of label information covered by a triangle from frame k to frame k+1;

FIG. 6 shows the 2D boundary recall as a measure of per frame segmentation quality;

FIG. 7 depicts the 3D undersegmentation error plotted over the number of supervoxels;

FIG. 8 shows the 3D undersegmentation error over the number of superpixels per frame;

FIG. 9 depicts the average temporal length over the number of superpixels per frame;

FIG. 10 schematically illustrates an embodiment of a method for generating an initial superpixel label map for a current image from an image sequence;

FIG. 11 schematically depicts one embodiment of an apparatus for generating an initial superpixel label map for a current image from an image sequence according to the present principles; and

FIG. 12 schematically illustrates another embodiment of an apparatus for generating an initial superpixel label map for a current image from an image sequence according to the present principles.

### DETAILED DESCRIPTION OF PREFERRED EMBODIMENTS

For a better understanding the principles of some embodiments shall now be explained in more detail in the following description with reference to the figures. It is understood that the proposed solution is not limited to these exemplary embodiments and that specified features can also expediently be combined and/or modified without departing from the scope of the present principles as defined in the appended claims.

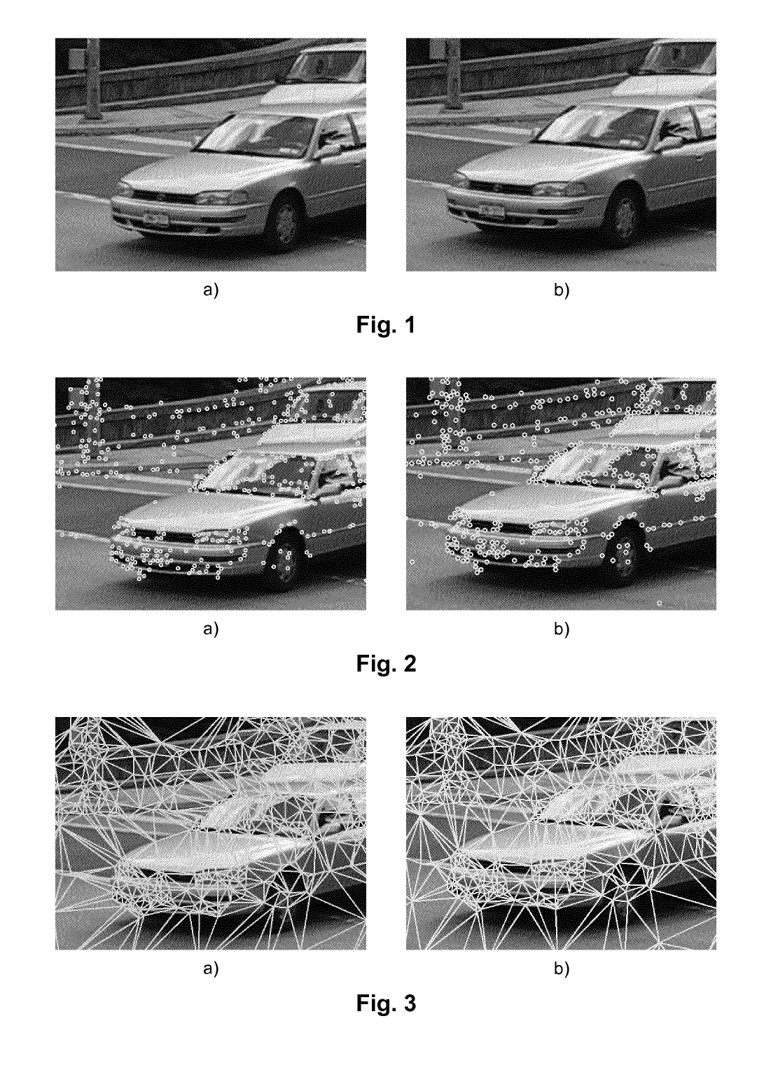

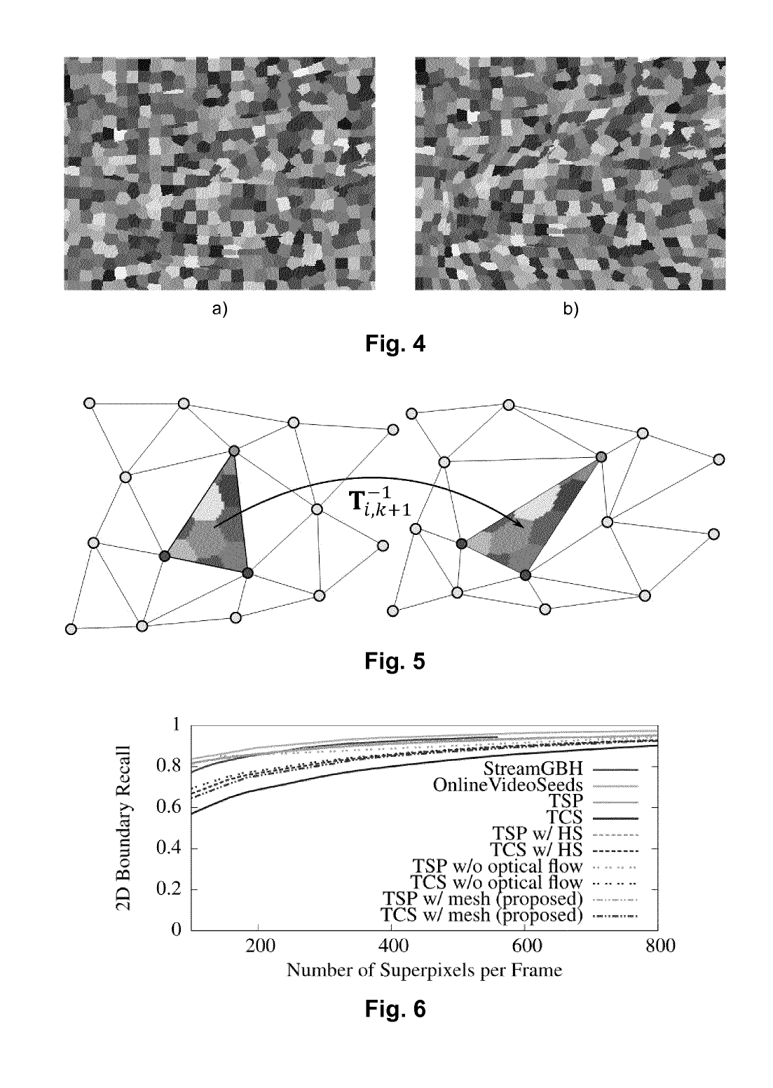

The present approach for a fast label propagation is visualized in FIGS. 1 to 4 for two sample video frames k shown in FIG. 1a) and k+1 shown in FIG. 1b). In FIG. 1 the original frames are cropped. In the case of a temporal image sequence the frames k and k+1 are temporally successive frames, though not necessarily immediately successive frames. In case of a multiview image, the frames k and k+1 are spatially neighboring frames, though not necessarily directly neighboring frames. Instead of calculating a dense optical flow as done, for example, in [3] and [4], only a set of sparse features is tracked between the current frame k and the next frame k+1, whose superpixel label map needs to be initialized. The features are calculated for frame k+1 using, for example, a Harris corner detector. In one embodiment, the method described in [5] is used to select so-called “good” features. These features are tracked back to frame k using, for example, a Kanade-Lucas-Tomasi (KLT) feature tracker. FIG. 2 shows the sparse features found in frame k+1, depicted in FIG. 2b), and tracked back into frame k, depicted in FIG. 2a). A cluster filter as it is proposed in [2] removes potential outliers. Using a Delaunay triangulation, for example, a mesh is generated from the features of frame k+1, as illustrated in FIG. 3b). Subsequently, the mesh is warped (backward) onto the superpixel label map of frame k, as shown in FIG. 3a), using the information provided by the KLT feature tracker. Under the assumption of a piece-wise planar surface in each triangle an affine transformation (with a transformation matrix T_{i,k+1}⁻¹) is used to warp the labels inside each triangle (forward) from frame k onto frame k+1, as can be seen in FIG. 5. The transformation matrix T_{i,k+1} in homogeneous coordinates for each triangle i between frame k+1 and k is determined using the three tracked feature points of the triangle:

$${T}_{i , k + 1} = [ \begin{matrix}{t}_{1 , i} & {t}_{3 , i} & {t}_{5 , i} \\ {t}_{2 , i} & {t}_{4 , i} & {t}_{6 , i} \\ 0 & 0 & 1\end{matrix} ] .$$

The Matrix elements t_{1,j} to t_{4,i} determine the rotation, shearing, and scaling, whereas the elements t_{5,i} to t_{6,i} determine the translation. Using this transformation matrix of the triangle the homogeneous coordinates of each pixel (x,y,1)ₖ₊₁^{T} in frame k+1 can be transformed into coordinates (\tilde{x},\tilde{y},1)ₖ^{T}; of frame k:

$$[ \begin{matrix}\tilde{x} \\ \tilde{y} \\ 1\end{matrix} ] = {T}_{i , k + 1} [ \begin{matrix}x \\ y \\ 1\end{matrix} ] .$$

The coordinates are clipped to the nearest valid pixel position. These are used to lookup the label in the superpixel label map of frame k, which is shown in FIG. 4a). The generated label map for frame k+1 is depicted in FIG. 4b). To ensure that each pixel is covered by a triangle, features at the four corners of the frame and at the middle of each frame border are inserted and tracked.

Occasionally after the warping some pixels are split-off from the main mass of a superpixel due to the transformation. As the spatial coherency of the superpixels has to be ensured, these fractions are identified and assigned to a directly neighboring superpixel. As this step is also necessary if a dense optical flow is used it does not produce additional computational overhead.

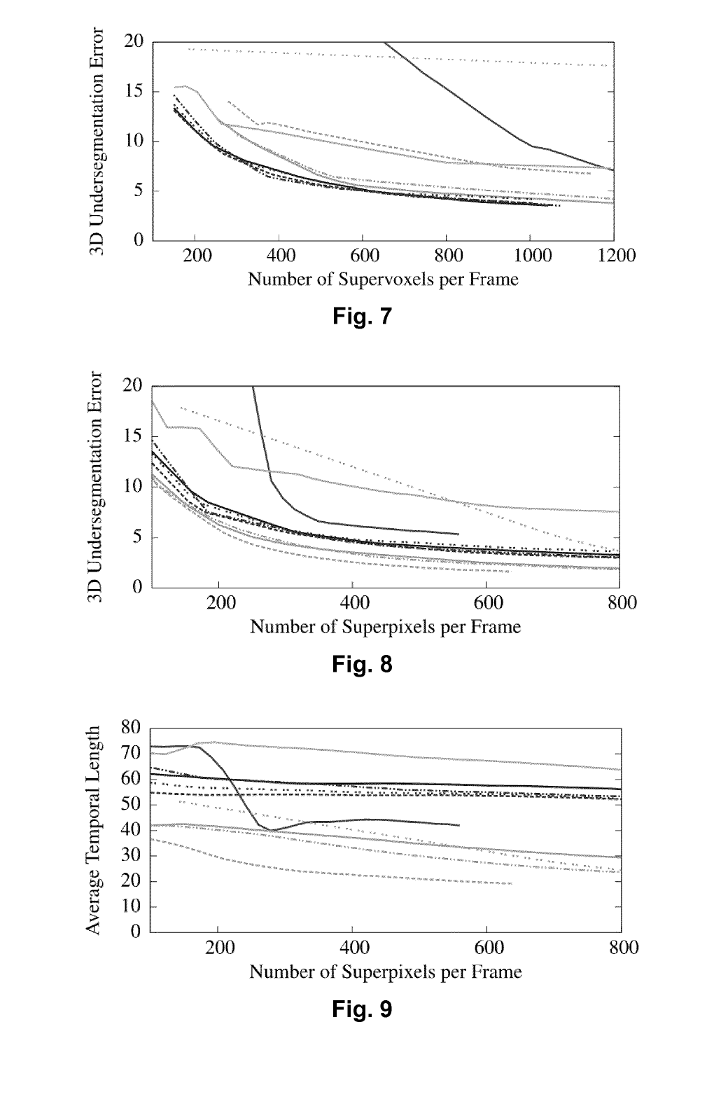

To analyze the performance of the proposed approach some benchmark measurements have been performed. The results are presented in FIGS. 6 to 9. FIG. 6 shows the 2D boundary recall as a measure of per frame segmentation quality. FIG. 7 depicts the 3D undersegmentation error plotted over the number of supervoxels. FIG. 8 shows the 3D undersegmentation error over the number of superpixels per frame. Finally, FIG. 9 depicts the average temporal length over the number of superpixels per frame. For a comparison the following approaches are included:
StreamGBH (Graph-based Streaming Hierarchical Video Segmentation) as a representative of the class of supervoxel algorithms [6];
TSP (Temporal Superpixels) in four versions: original version [3], with Horn&Schunck [8] as dense optical flow (w/HS), without optical flow (w/o optical flow), and with the approach proposed herein (w/mesh);
TCS (Temporally Consistent Superpixels) in four versions: original version [4], with Horn&Schunck as dense optical flow (w/HS), without optical flow (w/o optical flow), and with the approach proposed herein (w/mesh);
OnlineVideoSeeds as a state of the art method without utilization of optical flow information [7].

From the figures it can be seen that the proposed mesh-based propagation method produces a comparable segmentation error while the average temporal length is only slightly decreased. While the 2D boundary recall stays the same for the approach TSP w/mesh it is even improved for the approach TCS w/mesh.

In order to evaluate the runtime performance improvements in terms of computational costs the average runtime of the dense optical flow based label propagation and the mesh-based propagation was measured. Thereby, the label propagation method that is used in the original versions of TSP and TCS as well as a Horn&Schunck implementation is used as a reference. The performance benchmarks were done on an Intel i7-3770K @ 3.50 GHz with 32 GB of RAM. The results are summarized in Table 1.

From Table 1 it can be seen that the proposed method performs the superpixel label propagation task more than 100 times faster than the originally proposed methods while creating nearly the same segmentation quality as seen in FIGS. 6 to 9.

TABLE 1
Average runtime needed to propagate a superpixel
label map onto a new frame

| Label propagation method | Avgerage time/frame |
|---|---|
| Method used in TSP and TCS | 814.9 ms |
| Horn&Schunck | 114.3 ms |
| Proposed approach | 6.1 ms |

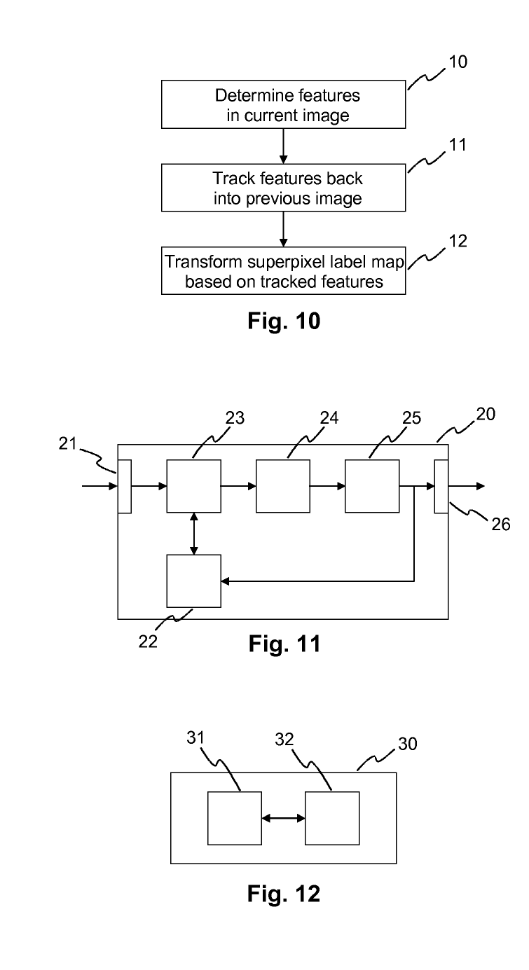

FIG. 10 schematically illustrates one embodiment of a method for generating an initial superpixel label map for a current image from an image sequence. In a first step features in the current image are determined 10. The determined features are then tracked 11 back into a previous image. Based on the tracked features, a superpixel label map associated to the previous image is transformed 12 into an initial superpixel label map for the current image.

One embodiment of an apparatus 20 for generating an initial superpixel label map for a current image from an image sequence according to the present principles is schematically depicted in FIG. 11. The apparatus 20 has an input 21 for receiving an image sequence, e.g. from a network or an external storage system. Alternatively, the image sequence is retrieved from a local storage unit 22. A feature detector 23 determines 10 features in the current image. A feature tracker 24 then tracks 11 the determined features back into a previous image. Based on the tracked features a transformer 25 transforms 12 a superpixel label map associated to the previous image into an initial superpixel label map for the current image. The resulting initial superpixel label map is preferably made available via an output 26. It may also be stored on the local storage unit 22. The output 26 may also be combined with the input 21 into a single bidirectional interface. Each of the different units 23, 24, 25 can be embodied as a different processor. Of course, the different units 23, 24, 25 may likewise be fully or partially combined into a single unit or implemented as software running on a processor.

Another embodiment of an apparatus 30 for generating an initial superpixel label map for a current image from an image sequence according to the present principles is schematically illustrated in FIG. 12. The apparatus 30 comprises a processing device 31 and a memory device 32 storing instructions that, when executed, cause the apparatus to perform steps according to one of the described methods.

For example, the processing device 31 can be a processor adapted to perform the steps according to one of the described methods. In an embodiment said adaptation comprises that the processor is configured, e.g. programmed, to perform steps according to one of the described methods.

A processor as used herein may include one or more processing units, such as microprocessors, digital signal processors, or combination thereof.

The local storage unit 22 and the memory device 32 may include volatile and/or non-volatile memory regions and storage devices such hard disk drives and DVD drives. A part of the memory is a non-transitory program storage device readable by the processing device 31, tangibly embodying a program of instructions executable by the processing device 31 to perform program steps as described herein according to the present principles.

### REFERENCES

[1] Ren et al.: “Learning a classification model for segmentation”, IEEE International Conference on Computer Vision (ICCV) (2003), pp. 10-17.
[2] Munderloh et al.: “Mesh-based global motion compensation for robust mosaicking and detection of moving objects in aerial surveillance”, IEEE Computer Society Conference on Computer Vision and Pattern Recognition (CVPR) (2011), 1st Workshop of Aerial Video Processing (WAVP), pp. 1-6.
[3] Chang et al.: “A Video Representation Using Temporal Superpixels”, IEEE Conference on Computer Vision and Pattern Recognition (CVPR) (2013), pp. 2051-2058.
[4] Reso et al.: “Superpixels for Video Content Using a Contour-based EM Optimization”, Asian Conference on Computer Vision (ACCV) (2014), pp. 1-16.
[5] Shi et al.: “Good features to track”, IEEE Conference on Computer Vision and Pattern Recognition (CVPR) (1994), pp. 593-600.
[6] Xu et al.: “Streaming Hierarchical Video Segmentation”, European Conference on Computer Vision (ECCV) (2012), pp. 1-14.
[7] Van den Bergh et al.: “Online Video SEEDS for Temporal Window Objectness”, IEEE International Conference on Computer Vision (ICCV) (2013), pp. 377-384.
[8] Horn et al.: “Determining optical flow”, Artificial Intelligence, Vol. 17 (1981), pp. 185-203.

1. A method for generating an initial superpixel label map for a current image from an image sequence, the method comprising:
determining features in the current image;
tracking the determined features back into a previous image; and
transforming a superpixel label map associated to the previous image into an initial superpixel label map for the current image based on the tracked features, the method further comprising adding features at the borders of the current image.

2. The method according to claim 1, further comprising generating meshes consisting of triangles for the current image and the previous image from the determined features.

3. The method according to claim 2, further comprising determining for each triangle in the current image a transformation matrix of an affine transformation for transforming the triangle into a corresponding triangle in the previous image.

4. The method according to claim 3, further comprising transforming coordinates of each pixel in the current image into transformed coordinates in the previous image using the determined transformation matrices.

5. The method according to claim 4, further comprising initializing the superpixel label map for the current image at each pixel position with a label of the label map associated to the previous image at the corresponding transformed pixel position.

6. The method according to claim 4, further comprising clipping the transformed coordinates to a nearest valid pixel position.

7. (canceled)

8. The method according to claim 1, further comprising assigning a pixel split-off from a main mass of a superpixel in the initial superpixel label map to a neighboring superpixel.

9. A computer readable storage medium having stored therein instructions for generating an initial superpixel label map for a current image from an image sequence, which when executed by a computer, cause the computer to:
determine features in the current image;
track the determined features back into a previous image; and
transform a superpixel label map associated to the previous image into an initial superpixel label map for the current image based on the tracked features, said instructions further causing the computer to add features at the borders of the current image.

10. An apparatus for generating an initial superpixel label map for a current image from an image sequence, the apparatus comprising:
a feature detector configured to determine features in the current image;
a feature tracker configured to track the determined features back into a previous image; and
a transformer configured to transform a superpixel label map associated to the previous image into an initial superpixel label map for the current image based on the tracked features
said apparatus being configured to add features at the borders of the current image.

11. An apparatus for generating an initial superpixel label map for a current image from an image sequence, the apparatus comprising a processing device and a memory device having stored therein instructions, which, when executed by the processing device, cause the apparatus to:
determine features in the current image;
track the determined features back into a previous image; and
transform a superpixel label map associated to the previous image into an initial superpixel label map for the current image based on the tracked features said instructions, when executed by the processing device, further causing the apparatus to add features at the borders of the current image.

12. The method according to claim 1, further comprising adding said added features at each corner and at the center of each border of the current image.

13. The computer readable storage medium according to claim 9, wherein said instructions further cause the computer to add said added features at each corner and at the center of each border of the current image.

14. The apparatus for generating an initial superpixel label map according to claim 10, wherein said apparatus is configured to add said added features at each corner and at the center of each border of the current image.

15. An apparatus for generating an initial superpixel label map according to claim 11, wherein said apparatus is configured to add said added features at each corner and at the center of each border of the current image.
